(19) United States
(12) Patent Application Publication
(10) Pub. No.: US 2026/0175119 A1
(43) Pub. Date: Jun. 25, 2026

(54) CLAW ASSEMBLY OF CLAW MACHINES

(71) Applicant: CHUNG-PO YANG, Kaohsiung City (TW)

(72) Inventor: CHUNG-PO YANG, Kaohsiung City (TW)

(21) Appl. No.: 19/026,365

(22) Filed: Jan. 17, 2025

(30) Foreign Application Priority Data
Dec. 25, 2024 (TW) 113150718

(51) Int. Cl. A63F 9/30

(52) U.S. Cl. CPC A63F 9/30

(57) ABSTRACT

The claw assembly for a claw machine includes a driving member and multiple claw members. The driving member is connected to the claw members, controlling them to perform gripping and releasing actions. Each claw member includes a support arm connected to the driving member, a connecting arm sleeved on the outer end of the support arm configured for linear telescopic movement without detachment, and a gripping arm sleeved on the outer end of the connecting arm configured for linear telescopic movement without detachment. The claw members can adjust the extension of the connecting arms and gripping arms as needed and can be controlled by the driving member to perform gripping and releasing actions. This design allows the arm length of the claw members to be adjusted telescopically according to demand, thereby enabling adjustments to the overall size of the claw assembly.

### BACKGROUND OF THE INVENTION

### (a) Technical Field of the Invention

The present invention generally relates to claw machines, and more particularly to a claw assembly employed in claw machines.

### (b) Description of the Prior Art

Claw machines, commonly found in arcades and entertainment venues, are enclosed cabinets filled with an assortment of prizes. Players use a joystick to control a mechanical claw, maneuvering it over the pile of prizes. The claw is then lowered into the pile in an attempt to grasp a prize, which can be retrieved through a chute if successfully captured.

As shown in FIG. 1, a conventional claw 10, commonly found in existing claw machines, includes a number of claw arms that can be controlled to grip or release. These claw arms 11 are of fixed dimensions. Consequently, the sizes of the claw 10 must be chosen to match the cabinet and prize dimensions, ensuring players can effectively grasp the prizes.

To provide a diverse playing experience, operators often install claw machines of various sizes, allowing players to grab different types and sizes of prizes (e.g., plush keychains, boxed models, food and beverages, household items, etc.). However, since the claw arms of current claw 10 are fixed in size, operators are required to purchase and stock multiple claws 10 of different dimensions for installation or replacement. This not only increases overall costs but also introduces inconveniences and complexities in replacing the claws 10, which remain areas for improvement.

### SUMMARY OF THE INVENTION

The objective of the present invention is to address the aforementioned issues by providing a claw assembly for claw machines capable of adjusting the arm length of the claw members according to demand, thereby enabling adjustment of the overall size of the claw assembly.

To achieve the above objective, the claw assembly includes a driving member and multiple claw members.

The driving member is connected to the claw members and can control and drive these claw members to perform gripping and releasing actions.

Each claw member includes a support arm, a connecting arm, and a gripping arm. The support arm is connected to the driving member. The outer end of the support arm is sleeved with the connecting arm, which is configured for linear telescopic movement relative to the support arm, without detachment. The outer end of the connecting arm is sleeved with the gripping arm, which is also configured for linear telescopic movement relative to the connecting arm, without detachment. This arrangement allows the claw members to adjust the extension of their connecting arms and gripping arms as needed. Additionally, the claw members can be controlled by the driving member to perform gripping and releasing actions.

Through the above-disclosed structure, the claw assembly can adjust the arm length of the claw members as needed, thereby enabling adjustments to the overall size of the claw assembly.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a conventional claw.

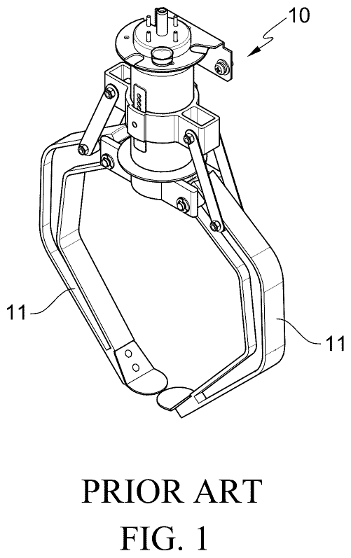

FIG. 2 is a perspective break-down diagram showing a claw assembly according to an embodiment of the present invention.

FIG. 3 is a sectional diagram showing a claw member of the claw assembly of FIG. 2.

FIG. 4 is a sectional diagram showing the extension and retraction of the connecting arm and gripping arm of the claw member of FIG. 3.

FIG. 5 is a sectional diagram showing the secured positioning of the connecting arm and gripping arm of the claw member of FIG. 3.

FIG. 6 is a side-view diagram showing the claw assembly of FIG. 2 whose connecting arms and gripping arms are retracted.

FIG. 7 is a side-view diagram showing the claw assembly of FIG. 2 whose connecting arms and gripping arms are extended.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

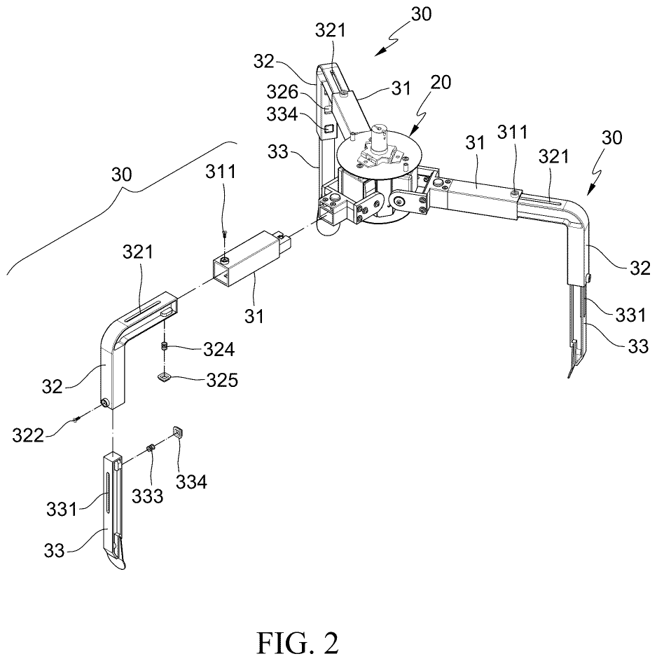

As shown in FIG. 2, a claw assembly according to an embodiment of the present invention includes a driving member 20 and a number of claw members 30.

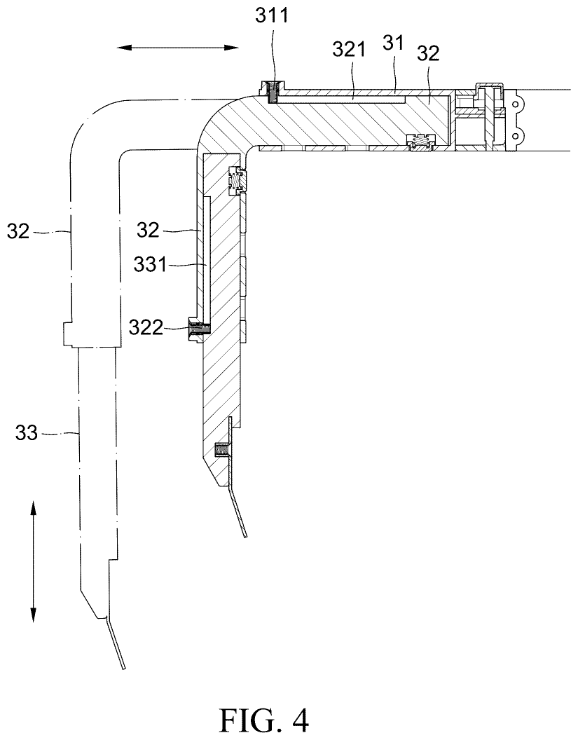

The claw members 30 are radially connected to the driving member 20 (see also FIG. 4). The driving member 20 can control the claw members 30 to grip or release.

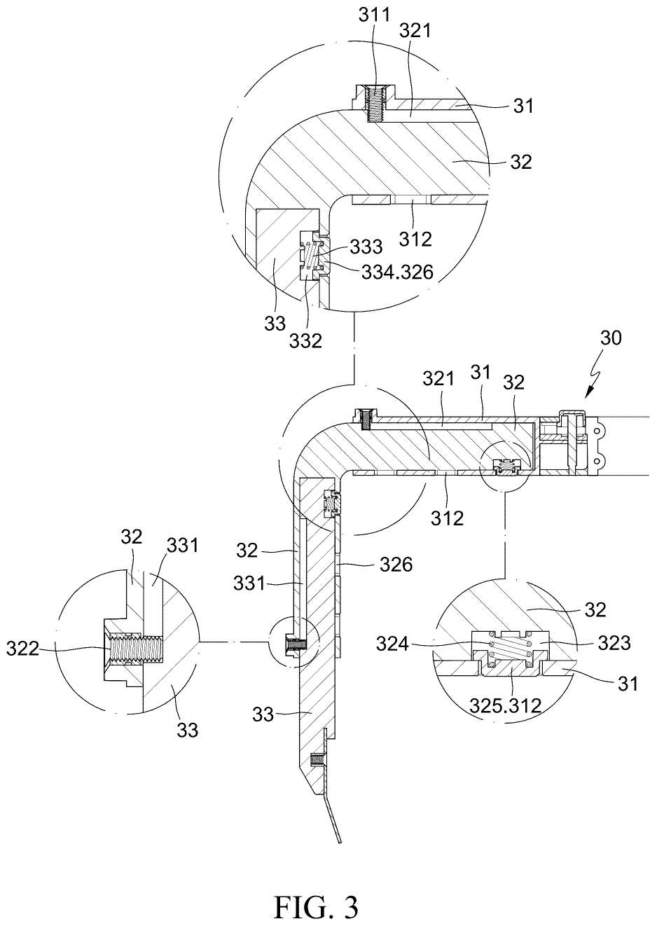

Each claw member 30 (see also FIGS. 3 and 4) includes a lateral support arm 31, an L-shaped connecting arm 32, and a vertical gripping arm 33. The inner end of the support arm 31 is connected to the driving member 20. A lateral section of the connecting arm 32 is slidably sleeved within the outer end of the support arm 31, allowing the connecting arm 32 to extend and retract linearly relative to the support arm 31 without becoming detached. The gripping arm 33 is slidably sleeved within the vertical section of the connecting arm 32, enabling the gripping arm 33 to extend and retract linearly relative to the connecting arm 32 without detachment. The claw members 30 can be adjusted as needed by modifying the extension of the connecting arm 32 and gripping arm 33, thereby altering the overall size of each claw member 30. Additionally, the claw members 30 can be controlled by the driving member 20 to perform gripping and releasing actions.

As shown in FIGS. 2 and 3, each support arm 31 is equipped with a positioning element 311 at its outer end. Each connecting arm 32 features an elongated positioning slot 321 on the outer surface of its lateral section, with the positioning element 311 of the support arm 31 extending into the positioning slot 321 of the connecting arm 32. Similarly, each connecting arm 32 is equipped with a positioning element 322 at the end of its vertical section, and each gripping arm 33 has an elongated positioning slot 331 on its outer surface, with the positioning element 322 of the connecting arm 32 extending into the positioning slot 331 of the gripping arm 33. This configuration ensures that the connecting arm 32 is constrained and secured by the positioning element 311 of the support arm 31, while the gripping arm 33 is constrained and secured by the positioning element 322 of the connecting arm 32.

Preferably, the positioning elements 311 and 322 of the support arm 31 and the connecting arm 32 are rotatable bolts that can be tightened or loosened as needed.

Preferably, as shown in FIGS. 2 and 3, the support arm 31 is evenly spaced with several positioning holes 312 on its bottom side. The front part of the connecting arm 32's lateral section is equipped with a groove 323 that corresponds to and is accommodated within the support arm 31. Inside the groove 323 of the connecting arm 32, a spring 324 and a positioning element 325 are installed. The spring 324 pushes the positioning element 325 downward, allowing the positioning element 325 to engage with one of the positioning holes 312 on the support arm 31, thereby securing the connecting arm 32 in a fixed position relative to the support arm 31. Similarly, the connecting arm 32 is evenly spaced with several positioning holes 326 on the inner side of its vertical section, and the front part of the gripping arm 33 is equipped with a groove 332 that corresponds to and is accommodated within the connecting arm 32. Inside the groove 332 of the gripping arm 33, a spring 333 and a positioning element 334 are installed. The spring 333 pushes the positioning element 334 outward, allowing the positioning element 334 to engage with one of the positioning holes 326 on the connecting arm 32, thereby securing the gripping arm 33 in a fixed position relative to the connecting arm 32.

As described above, the support arm 31 and the connecting arm 32, as well as the connecting arm 32 and the gripping arm 33, are designed in a telescopic sleeve configuration. Additionally, the support arm 31, connecting arm 32, and gripping arm 33 are configured for linear extension and retraction. As a result, each claw member 30 can adjust the overall length of its claw arms as needed, thereby allowing the overall size and gripping range of the claw members 30 to be customized. This effectively expands the applicability of the claw members 30 in various scenarios.

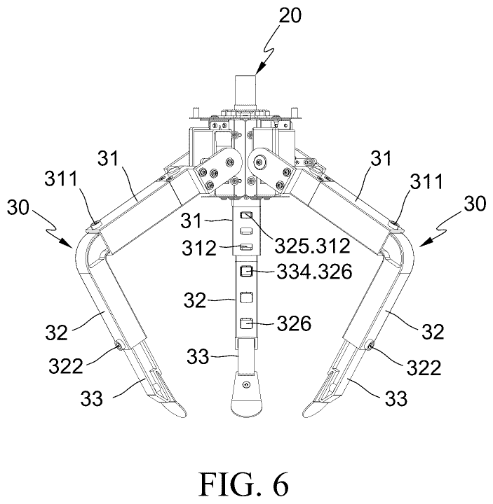

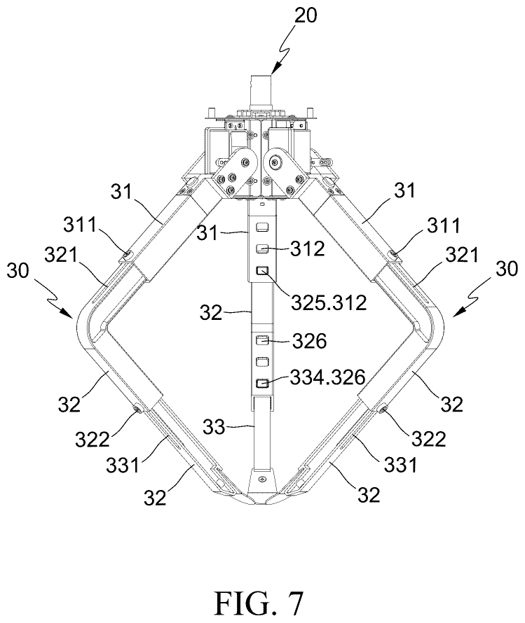

As shown in FIG. 4, the positioning elements 311 and 322 of the support arm 31 and the connecting arm 32, respectively, extend into the positioning slots 321 and 331 of the connecting arm 32 and the gripping arm 33 for alignment and fixation. Operators can freely adjust the connecting arm 32 and the gripping arm 33 to the desired positions and then secure them in place using the positioning elements 311 and 322 of the support arm 31 and the connecting arm 32 (as illustrated in FIGS. 6 and 7). This completes the size adjustment process for each claw member of the claw assembly of the present invention. Accordingly, the present invention allows operators to infinitely and freely adjust the overall size of the claw assembly, providing convenience, speed, and flexibility in changing the claw assembly's dimensions.

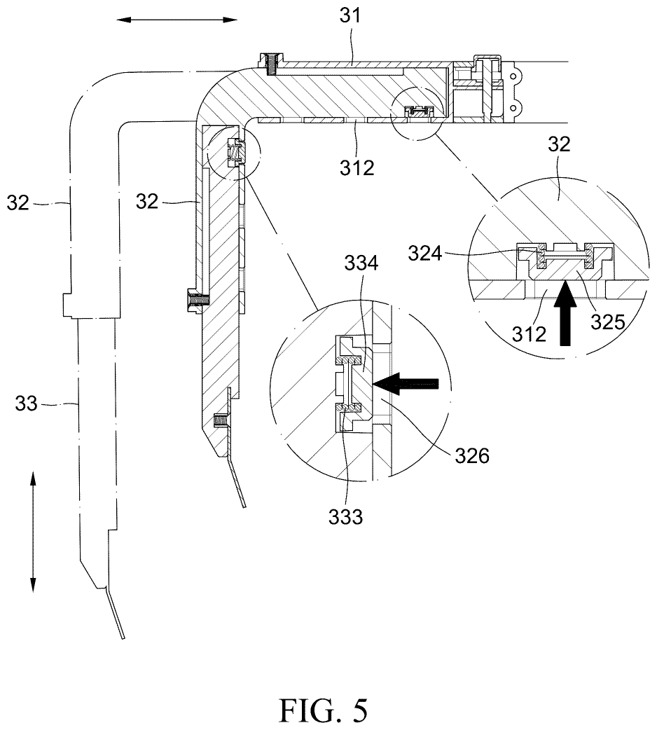

Additionally, as shown in FIG. 5, the support arm 31 and connecting arm 32 are evenly spaced with positioning holes 312 and 326, respectively, while the connecting arm 32 and gripping arm 33 are correspondingly equipped with positioning elements 325 and 334. Operators can press the positioning elements 325 and 334 on the connecting arm 32 and gripping arm 33, causing the springs 324 and 333 to compress inward, disengaging them from the positioning holes 312 and 326 on the connecting arm 32 and gripping arm 33. This allows the operator to extend or retract the connecting arm 32 and gripping arm 33 as needed. When the positioning elements 325 and 334 move to align with other positioning holes 312 and 326 on the connecting arm 32 and gripping arm 33, the springs 324 and 333 push the positioning elements 325 and 334 outward, allowing them to re-engage with the positioning holes 312 and 326. This secures and fixes the connecting arm 32 and gripping arm 33 in place, completing the size adjustment process for the claw member 30 (as illustrated in FIGS. 6 and 7). Accordingly, this invention provides operators with the ability to adjust the overall size of the claw assembly in steps, offering convenience and speed in modifying the claw assembly's dimensions.

From the above description, it can be understood that the claw members 30 of this invention are designed with a telescopic configuration. As a result, the overall size of the claw assembly can be adjusted by extending or retracting as needed, which not only increases the overall arm length and gripping range but also eliminates the need for operators to purchase and stock multiple sizes of claw assemblies, thereby significantly reducing overall costs. Additionally, the telescopic design of the claw members 30 provides enhanced convenience, speed, and flexibility when adjusting the claw assembly's size.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A claw assembly for claw machines, comprising:
a plurality of claw members, and
a driving member connected to the claw member, where the driving member controls the claw members to grip or release;
wherein each claw member comprises a supporting arm, a connecting arm, and a gripping arm;
the support arm is connected to the driving member;
an outer end of the support arm is sleeved with the connecting arm, which is configured for linear telescopic movement relative to the support arm without detachment;
an outer end of the connecting arm is sleeved with the gripping arm, which is configured for linear telescopic movement relative to the connecting arm without detachment;
the claw members are adjustable by extending and retracting their connecting arms and gripping arms; and
the claw members are controlled by the driving member to perform gripping and releasing actions.

2. The claw assembly according to claim 1, wherein the support arm is equipped with a positioning element; the connecting arm is equipped with a positioning slot; the positioning element of the support arm extends into the positioning slot of the connecting arm, allowing the connecting arm to be constrained and secured by the positioning element of the support arm; the connecting arm is equipped with a positioning element; the gripping arm is equipped with a positioning slot; the positioning element of the connecting arm extends into the positioning slot of the gripping arm, allowing the gripping arm to be constrained and secured by the positioning element of the connecting arm.

3. The claw assembly according to claim 1, wherein the support arm is evenly spaced with a plurality of positioning holes; a front side of the connecting arm is equipped with a groove that corresponds to and is accommodated within the support arm; inside the groove of the connecting arm, a spring and a positioning element are installed; the spring pushes the positioning element outward, allowing the positioning element of the connecting arm to engage with the positioning holes of the support arm, thereby securing and fixing the connecting arm relative to the support arm; the connecting arm is evenly spaced with a plurality of positioning holes; a front side of the gripping arm is equipped with a groove that corresponds to and is accommodated within the connecting arm; inside the groove of the gripping arm, a spring and a positioning element are installed; the spring pushes the positioning element outward, allowing the positioning element of the gripping arm to engage with the positioning holes of the connecting arm, thereby securing and fixing the gripping arm relative to the connecting arm.

4. The claw assembly according to claim 2, wherein the positioning elements of the support arm and the connecting arm are rotatable bolts that can be tightened or loosened.
